(19) United States
(12) Patent Application Publication
(10) Pub. No.: US 2009/0119766 A1
(43) Pub. Date: May 7, 2009

(54) Method for Remotely Accessing a Local Area Network, and Switching Node for Carrying Out the Method

(75) Inventors: Ingo Huetter, Pattensen (DE); Michael Weber, Hannover (DE)

Correspondence Address: Robert D. Shedd;Thomson Licensing LLC, PO Box 5312, PRINCETON, NJ, 08543-5312, US

(73) Assignee: THOMSON LICENSING, Boulogne-Billancourt (FR)

(21) Appl. No.: 11/989,026

(22) PCT Filed: Jul. 5, 2006
(86) PCT No.: PCT/EP2006/063885

§ 371 Date: Jan. 18, 2008

(30) Foreign Application Priority Data
Jul. 22, 2005 (DE) 10 2005 034 972.2

(51) Int. Cl. G06F 21/00

(52) U.S. Cl. 726/12

(57) ABSTRACT

The invention relates to the technical field of data transmission in a network of distributed stations. One problem particularly with a UPnP-based home network is that although the network-internal communication is based on the IP protocol, the allocated IP addresses are valid only locally and they therefore cannot be accessed via the Internet. This is the starting point of the invention, which proposes that remote access to the network have the network's switching node provide address conversion which is effected using an internally managed table about the devices which are present in the network and their IP addresses. For the remote access, the globally valid IP address of the switching node is used, with an additional information item being additionally provided in the HTTP Get remote access and allowing the address conversion. A suitable additional information item is the converted local IP address of the network station which is to be addressed, in particular. The response to the remote access involves the inverse address conversion, so that the references back to the local area network again contain the globally valid address of the switching node plus the additional information item.

The invention relates to the technical field of remote access to a local area network, particularly a home network. The remote access is effected via the Internet.

### BACKGROUND TO THE INVENTION

Various home network standards are available for networking devices in the home sector. A consortium of companies, particularly companies in the computer industry, led by Microsoft, have started an initiative for specifying a piece of network control software, based on the existing Internet Protocol (IP). This network system has become known by the abbreviation UPnP (Universal Plug-and-Play). The UPnP system is based on a series of standardized network protocols and data formats. It is used for controlling devices from different manufacturers (including typical devices in the computer industry, such as PCs, routers, printers, scanners and devices in consumer electronics and also white-goods household appliances and building controllers). The devices are networked via an IP based network, with or without central control by a “residential gateway”. In this case, the network system is in the form of a plug-and-play system, i.e. the network is configured without any interaction by the user. A control point device, accordingly a Control Point, can find the devices in the network automatically. Suitable physical transmission media are all media which support IP communication, that is to say, by way of example, Ethernet, Firewire, radio transmission systems such as Bluetooth and wireless LAN etc. Standardized technologies are used such as IP, UDP (accordingly the User Datagram Protocol), Multicast, TCP, accordingly the Transmission Control Protocol, HTTP, accordingly the Hyper Text Transfer Protocol, XML, accordingly the Extended Markup Language, SOAP, accordingly the Simple Object Access Protocol, and SSDP, accordingly the Simple Service Discovery Protocol.

Since the basis of UPnP is an IP network, a network device or a control point device must first of all have a valid IP address. On the basis of the UPnP standard, this can be done firstly using DHCP, accordingly the Dynamic Host Configuration Protocol, or using Auto-IP. These protocols are used to make a dynamic IP address allocation, from the range of local IP addresses, i.e. the devices in the network cannot be addressed directly via the Internet externally. This would require global IP addresses, which are not normally allocated in the home sector.

### INVENTION

The invention relates to the problem of allowing remote access to the network stations in the local area network using associated locally valid IP addresses.

The solution based on the invention is to perform address conversion at a switching node, that is to say the node which provides the local area network with access to the Internet, when remote access is to be used to address a network station in the local area network. This is because the switching node, as the sole subscriber in the local area network, has an associated globally valid IP address. If a network station is now accessed remotely, the remote access is effected using the globally valid IP address. However, an additional information item is likewise provided which may relate to the local IP address of the network station which is to be addressed, for example. This additional information item is then used at the switching node to perform the beforementioned address conversion, i.e. the globally valid IP address for the remote access is converted into the locally valid IP address of the network station which is to be addressed. This is done using the additional information item communicated during the remote access. To this end, the switching node manages an appropriate table in which, by way of example, the device names and associated local IP addresses are listed. This measure allows a network station in the local area network to be accessed externally, i.e. via the Internet. To cope with the security aspect of such access, additional security measures may be taken, such as password protection, encrypted transmission, a Firewall and so on.

The measures presented in the dependent claims allow advantageous developments and improvements of the method specified in Claim 1. Thus, by way of example, inverse address conversion is advantageously performed for the response to the remote access, so that the sender address entered for the response is the globally valid IP address of the switching node plus the additional information item instead of the locally valid IP address of the network station.

In order to implement a control function for a network station in the local area network, it is advantageous if the switching node provides an Internet reference, that is to say an Internet link, to an Internet page on the device to be addressed which has been generated using description language, the Internet reference indicating the global address of the switching node plus the additional information item. If this Internet link is now called by remote access, the switching node converts this access back into the locally valid address and the called document found there (e.g. HTML page) is returned.

The address conversion in one or the other direction can be effected by an appropriately programmed application program at the switching node.

Another possibility for making a network station functionality available is likewise to use an Internet reference, but in this case to a document which has been programmed using script language and which can be found at the switching node. This document is an executable document to which certain parameters can be transferred when this document is accessed. The invention provides that the parameter transferred is at least one station descriptor and/or the local IP address, and also the name and/or the link for the function which is to be executed. When the called script is executed, the address conversion is performed and the page corresponding to the functionality is called in the network station again.

For a switching node based on the invention, it is advantageous if it has address conversion means which, in the event of remote access to a network station with a locally valid address, convert the globally valid address to the locally valid address of the network station using the additional information item which is delivered at the same time.

It is advantageous if the switching node contains a device ascertainment module which manages a list of the network stations which are present in the network. Depending on the form, two different lists for the active network stations and the inactive network stations can be managed, or one joint list is managed in which the active or inactive network stations are flagged separately.

It is particularly advantageous if the switching node contains means which generate a wakeup message for an inactive network station when this inactive network station is accessed remotely. For this purpose, a Wake-On-LAN data packet, in particular, can be sent to the inactive network station.

It is likewise advantageous if the switching node has means which provide the aforementioned Internet reference to an Internet page on a network station which has been generated using description language, but this Internet reference indicates the global address of the switching node plus the additional information item. The reason for this is that an Internet reference with a locally valid IP address is not possible because such an address is not unique.

It is equally advantageous if the means for providing an Internet reference refer to a document programmed using script language, the Internet reference indicating the global address of the switching node plus the additional information item, and the document program using script language being designed to accept at least the local IP address as a parameter.

### DRAWINGS

Exemplary embodiments of the invention are shown in the drawings and are explained in more detail in the description below.

In the drawings:

FIG. 1 shows the structure of a local area network with a switching node for connection to the Internet;

FIG. 2 shows a protocol overview for the inventive switching node;

FIG. 3 shows a block diagram of the inventive switching node;

FIG. 4 shows the illustration of the software components in an inventive network station or the switching node;

FIG. 5 shows a flowchart for the remote access to a device in the local area network;

FIG. 6 shows the main page of a media server in the local area network;

FIG. 7 shows the page for a content directory on the media server in the local area network;

FIG. 8 shows the page for a picture directory on the media server in the local area network;

FIG. 9 shows the page displaying a picture, selected by remote access, in the subdirectory for the travel pictures;

FIG. 10 shows an example of remote access to a content directory-on a network station in the local area network using a UPnP application at the switching node by converting the HTTP request from the remote computer into a UPnP request and converting the response of the UPnP request into the HTML page requested by the remote computer;

FIG. 11 shows an example of remote access to the presentation page on a network station in the local area network with conversion into HTTP access with the local IP address and conversion of the local links or local links in forms into global links or global links in forms;

FIG. 12 shows the presentation pages for directory structure on the web server of a network station in the local area network;

FIG. 13 shows an extract from the presentation page of a network station in the local area network;

FIG. 14 shows the presentation page following the conversion of a local link or a local link in a form into a global link or a global link in a form by the switching node using virtual path details for encoding information for the later conversion of the links into the local area network; and

FIG. 15 shows the presentation page following the conversion of a local link or a local link in a form into a global link or a global link in a form by the switching node using script parameters for encoding information for the later conversion of the links into the local area network.

### DESCRIPTION OF THE INVENTION

FIG. 1 shows an exemplary home network with four network stations 11 to 14. In addition, the network contains a switching node 10, which is also called a router. An output of the router 10 provides a connection to the Internet 15. The network station 14 is wirelessly connected to the switching node 10, e.g. by means of Wireless LAN, accordingly IEEE802.11b. The bus connections between the switching node 10 and the network stations 11 to 13 are based on Ethernet technology; specifically, 100 base/TX Ethernet may be used. The switching node 10 is simultaneously in the form of a network connection switching unit, accordingly a network switch, and also in the form of a wireless access point. In this respect, the arrangement may also be of a different nature, namely by virtue of the switching node 10 being provided as a separate component in the network, connected to a separate network connection switching unit.

The transmission system used for data transmission in the network is the aforementioned Ethernet bus system. Many different variants of this bus system are known. For the chosen instance of application, the 100 base/TX variant has been regarded as sufficient, but in other instances of application it is possible to use a different variant as transmission system. If relatively high data rates are important, it is possible to use “1000 base/T” or “1000 base/SX” or 1000 base/LX”, for example. The last two variants are based on optical fibre technology in this case. The network shown in FIG. 1 is UPnP-based, i.e. the individual network stations are designed on the basis of the UPnP standard. The reference numeral 16 denotes a component which is connected via the Internet and which is intended to allow remote access to the network. All network stations, such as the switching node 10 and the remote computer 16 too, have exemplary IP addresses indicated for them. These addresses are based on the IPv4 standard, i.e. they are 32-bit addresses. The addresses for the network stations 11-14 respectively start with the two numbers 192.168 and, on the basis of IPv4, come from an address range which is reserved for private networks. These addresses are not allocated further by the address management authority for the Internet IANA, accordingly the Internet Assigned Numbers Authority, and are not communicated on the Internet. For this reason, these addresses cannot be addressed by means of remote access. The switching node 10 also has a locally valid IP address of this type associated with it so that the data traffic operates without friction internally in the local area network. In addition, the switching node 10 has also been allocated a globally valid address, however. In line with FIG. 1, this is the address 216.216.216.216. This address is a unique IP address based on IPv4 which is accordingly also routed and can therefore be addressed from the Internet. The IP address 81.81.81.81 allocated to the remote computer 16 also corresponds to a globally valid IPv4 address.

For the remote access, the remote computer 16 needs to have implemented the following protocols: the Ethernet, if it is connected by means of an Ethernet bus, IP, accordingly the Internet Protocol, TCP, accordingly the Transmission Control Protocol, and also HTTP (accordingly the Hyper Text Transfer Protocol) protocols.

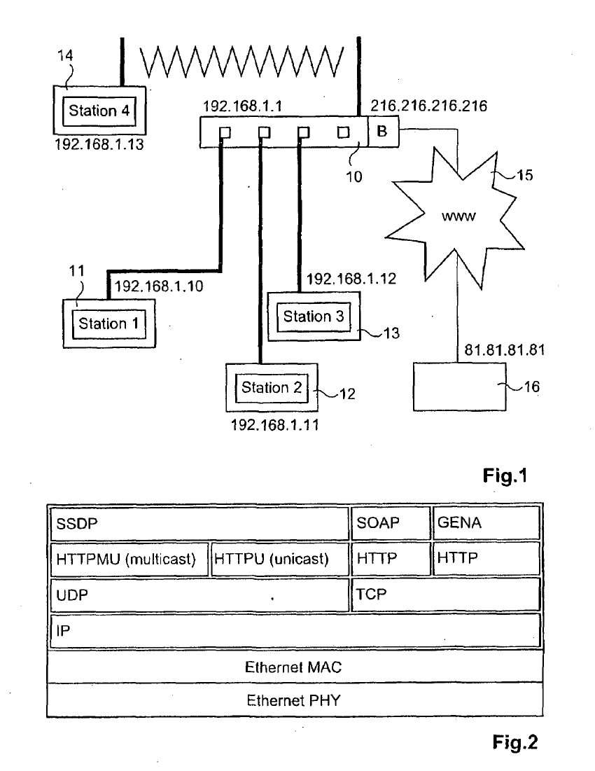

Communication in the UPnP network requires an extended protocol stack for the individual network stations. This protocol stack is shown in FIG. 2. The two Ethernet protocol levels Ethernet PHY and Ethernet MAC are arranged on the lowest levels. Above them is the aforementioned protocol level IP. The transport layer level then has the UDP protocol arranged on it, which is used for transmitting all messages related to device recognition (Device Discovery). Above this is a special version of the HTTP protocol. This is the HTTPMU (HTTP multicast over UDP) protocol. HTTP messages of this kind are therefore blanket-addressed and forwarded via the lower UDP and IP protocol levels.

Above the HTTPMU protocol level, there is also the SSDP (Simple service Discovery Protocol) protocol. Besides the UDP protocol, the TCP protocol is also used, which is provided for transmitting all other UPnP messages, particularly for devices, service descriptions, for device control and for event notification. Above this is the HTTP protocol and above that, on the level of the SSDP protocol, the SOAP protocol, denoted earlier as the Simple Object Access Protocol. This protocol is to be implemented only optionally, however, and only needs to be used when the switching node is providing UPnP applications. In addition, the GENA, accordingly the General Event Notification Architecture, protocol may also be implemented, which allows registrations for event notifications in other network stations.

A full protocol architecture which is used in the UPnP network system can be found in the UPnP specification (available at www.upnp.org).

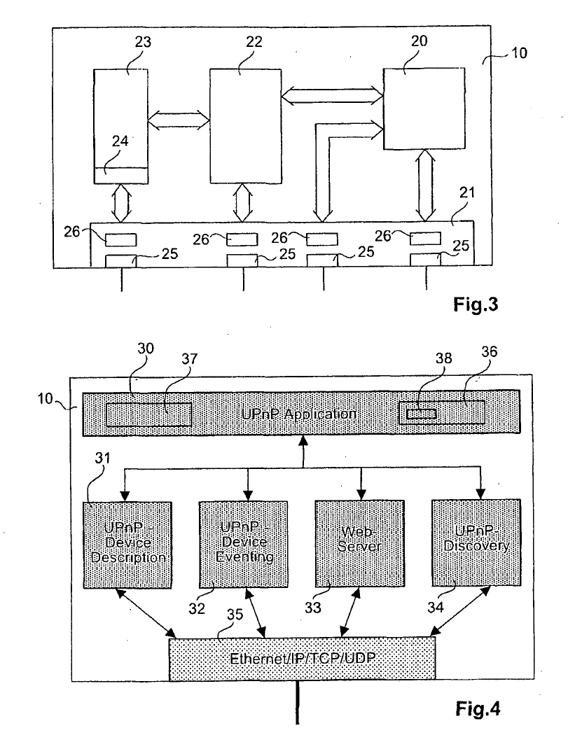

The design of the inventive switching node 10 is explained below with reference to FIG. 3. In this figure, the reference numeral 20 denotes a switching matrix. This can be used to set up arbitrary connections between the network stations connected via the network connection points 25. The switching matrix 20 is controlled using a microcontroller 22 in the network connection switching unit 10. This microcontroller also executes the various software components, which will be explained in more detail below, and also the various protocols. The interface circuit 21 contains the circuit components which are relevant to the Ethernet protocol. The reference numeral 23 denotes a memory unit or a memory area in such a unit. This memory 23 is used to record the information which is required for address conversion, for example. The reference numeral 24 also denotes a special register within this memory area, said special register being linked directly to detection means 26 which are provided in the interface circuit 21 and which detect whether a network connection has been cleared manually. In simple terms, pulling out a network connector opens or closes particular contacts in these detection means, which results in associated storage flip-flops being set or reset. In the case of the solution with the special register 24 situated in the memory area 23, mentioned by way of example, the flip-flop outlets are applied directly to an interrupt input, which then addresses the microcontroller 22, which can perform appropriate evaluation.

A suitable network connection point 25 can be found in the usual connectors for taking known RJ45 connectors.

FIG. 4 shows a few software components at a switching node 10 which has been adapted in line with the invention. The reference numeral 35 denotes a protocol stack, comprising the protocol levels Ethernet, IP, TCP and UDP. Reference numeral 31 corresponds to the software component storing the UPnP device description. Reference numeral 32 denotes a software component which manages event notifications, accordingly UPnP Eventing. A standard component of the UPnP device is also a web server 33. The reference numeral 34 denotes a UPnP discovery unit. Above these blocks, a UPnP application program is also denoted by the reference numeral 30. All of these units are standard components in a UPnP device and are described accurately in the UPnP specification.

The reference numeral 36 denotes the inventive address conversion means within the UPnP application. Within this unit, both the individual IP addresses of the network stations 11 to 14 and the Ethernet MAC addresses and the associated device names are registered. The associated table is labelled with the reference numeral 38.

The text below explains the use of a network station by remote access and the process of address conversion in more detail. As already mentioned above, each UPnP device has a web server. This web server 33 may be used to provide one or more presentation pages in the form of HTML documents, which are also used for controlling the device. The manufacturer is therefore able to provide not only standardized access by means of SOAP notifications to the control URL of the device but also an alternative user interface which is HTML-based. Both opportunities may be utilized for remote access.

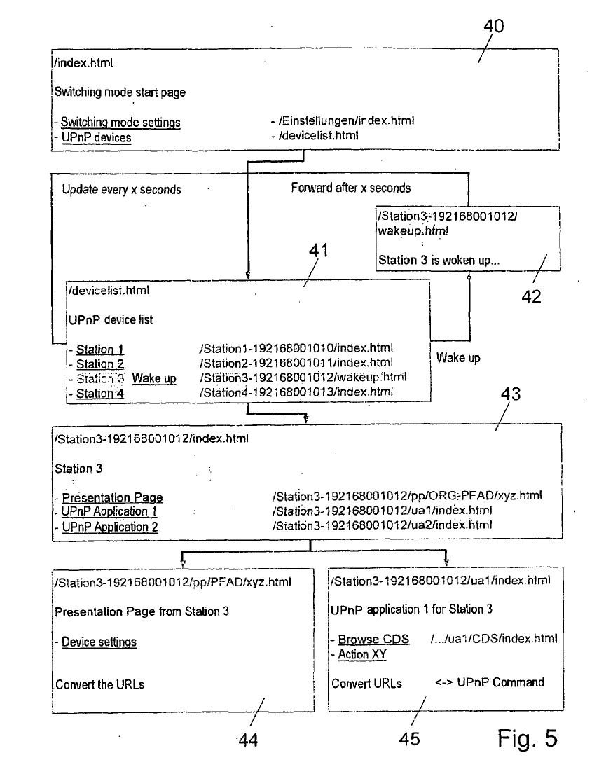

FIG. 5 shows an overview of the cycle of communication by remote access. First of all, the remote computer 16 accesses the index page at the switching node 10. This is done using a web browser which is installed on the remote computer 16 and which can be used to select an Internet page. The index page is provided with the reference numeral 40. It contains two entries, a reference to an HTML page for the settings for the switching node and a reference to an HTML page on which the UPnP devices in the network are listed.

It will be assumed that the user selects the menu item for the list of UPnP devices. The HTML page 41 which has the UPnP device list and which is situated under the associated link is then set up. An HTML META tag can be used to ensure that the page is updated periodically, e.g. every 5 s, so as always to show the current status of the devices. This is indicated in the flowchart in FIG. 5. On the HTML page 41, greyscale differentiation indicates that the station 3 is currently not active in the network, but it can be activated by selecting the menu item “Wakeup”.

It will be assumed that the user, for his part, selects the menu item “Wakeup” next to the station 3. An HTTP Get request is then created in the remote computer 16 and goes to the switching node 10. This request contains not only the domain name, which is not shown, for the local area network but also a unique station descriptor, e.g. the local IP address of the station 3 in converted form, as shown in FIG. 5. The local IP address of the station 3 is 192.168.1.2. This address is indicated in the link to the station 3 in the form Station3-192168001012. The information Station3-192168001012 has been discovered by the remote computer 16 via the HTML page at the switching node 10. The switching node incorporates this information into the links on the HTML page (e.g. UPnP devices list or UPnP application at the switching node) and into the links on the presentation pages. Dots in such links have a special meaning and are therefore avoided. To make the address statement unique, up to two leading zeros are inserted instead of the respective dot.

The URL also contains the descriptor for the HTML page Wakeup.html. When this URL is selected, an HTTP Get request is sent to the switching node 10, which then sends a wakeup message in the form of a Wake-On-LAN data packet to the inactive station 3. A Wake-On-LAN data packet of this kind is of very simple design. It comprises a single Ethernet data frame which, somewhere in its payload, contains a preamble of 6 bytes with the respective value 0×FF, then followed by 16 times the hardware address (MAC address) of the network station which is to be woken up. The switching node selects the Ethernet address allocated to the station 3 from an internal table. For further details on the Wake-On-LAN capability of a network station, you are referred to the article by Benjamin Benz (“Netzwerk Wecker” in the periodical ct, 2005, No 2, pages 200-201). Measures which need to be taken in a network station and at a switching node in order to maintain participation of a network station in the network even when the device has been switched to a power-saving mode of operation are known from the parallel German Patent Application from the applicant with the application number 10 2005 027 387.4. In this regard, reference is made to this patent application expressly.

Using an HTML META tag, it is possible to jump automatically from the Wakeup HTML page 42 to the HTML page 41 containing the device list after a certain period of time. This is likewise shown in the flowchart.

The woken station communicates its presence in the network using a logon message ssdp:alive. The entry in the table in the network stations is updated for the woken device. In the HTML page 41 displayed using the web browser, the greyscale differentiation for station 3 in the station list is then removed and this station is also flagged as an active device.

It is then assumed that the user selects the station 3. The relevant HTTP Get request results in the setup of the index page 43 for the network station 3 in the remote computer 16. This page lists three menu items. One menu item relates to the selection of the presentation page on a device. The other two menu items relate to the selection of two UPnP application programs. Below the index page for the station 3, the presentation page 44 for the station is shown on the left. To the right of this, the index page 45 for the UPnP application 1 is shown. A menu item can be used to retrieve the content directory for the station 3. The associated links are not shown on these two pages for reasons appertaining to the illustration.

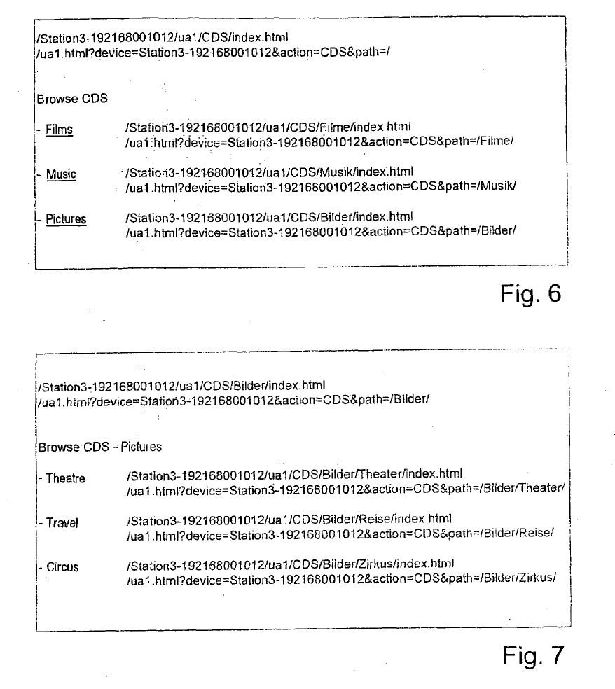

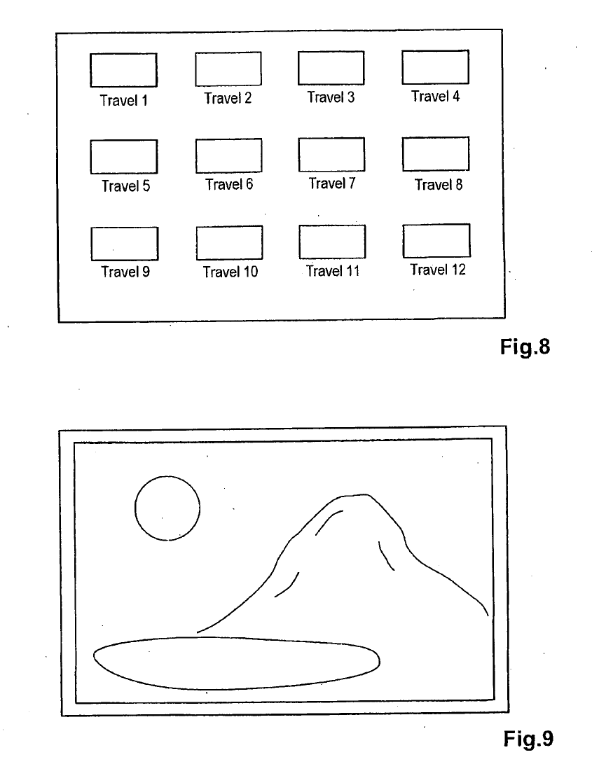

The start page for the UPnP application Browse Content Directory is outlined in FIG. 6. There are directories for film, music and pictures. The user selects the menu item Pictures, for example. This shows picture subdirectories for various picture albums, see FIG. 7. It will be assumed that the user of the remote computer 16 selects the subdirectory for the travel pictures. The remote computer 16 then sends the relevant request to the switching node 10. As FIG. 8 shows, the associated HTML page for the available pictures in the travel subdirectory is loaded. In the picture shown, there is an indication that a respective preview of the individual pictures is also displayed. This is a reduced picture which is respectively displayed above the name of the picture.

The user of the remote computer 16 is then able to select one of the pictures displayed. It will be assumed that he selects the picture Travel 1. For this selection too, an HTTP Get request is formed which is sent to the switching node 10. The path and the file name Reise1.jpg are indicated therein. The station 3 returns the desired picture, which is displayed on the remote computer 16, as shown in FIG. 9.

The process of address conversion is explained below using exemplary embodiments. In FIG. 5, the HTML pages respectively indicate only the internal path plus the file name of the respective page. To be able to call these pages by remote access, the remote computer needs to address the switching node using its global address. Instead of the global address, the domain name can be specified. The statement of the domain name, e.g. www.homenetxyz.net conceals the global Internet address 216.216.216.216 of the switching node 10. The association between domain name and IP address and vice versa is made using the domain name system DNS, available worldwide, or a service such as DYNDNS, which allows domain names to be converted to dynamic IP addresses. The remote access sends an HTTP Get call to the switching node 10.

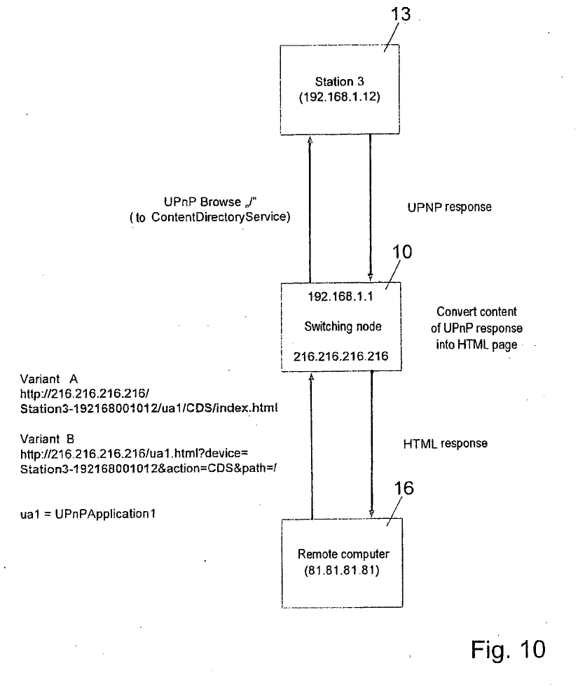

FIG. 10 shows the HTTP Get call from the remote computer to the switching node. In line with variant A, the global address of the switching node holds the name of the UPnP device and its IP address Station3-192168001012. In addition, the path contains the statement ua1 for the UPnP application 1 at the switching node for the station 3 and CDS for the content directory from station 3. The file index.html is the start page for the application at the switching node for accessing the content directory for the network station 3. Since the switching node has generated the link itself for the remote computer, it knows the structure of the link and thus has all the information which it requires for handling the request. The additional information item Station3-192168001012 tells the address conversion means at the switching node 10 that the desired document is not itself held at the switching node, but rather that the necessary information needs to be requested from the station 3. The addition ua1 tells the switching node 10 that the request has been sent to its UPnP application 1, and the addition/CDS/index.html tells the UPnP application 1 that the start page of the content directory needs to be displayed. The UPnP application 1 then sends a UPnP Browse instruction to the content directory service (ContentDirectoryService CDS) of the station 3. The UPnP response from the network station 3 contains a list of media files and directories which are present on the requested directory level of the content directory for the station 3. From this list, the UPnP application 1 produces an HTML page containing appropriate global links, e.g. http://216.216.216.216/Station3-192168001012/ua1/CDS/Bilder/index.html for a subdirectory Pictures in the content directory of the station 3. In summary, FIG. 10 shows an example of remote access to a content directory on a network station in the local area network using a UPnP application at the switching node by converting the HTTP request from the remote computer into a UPnP request and converting the response for the UPnP request into the HTML page requested by the remote computer.

An alternative form of control for a UPnP device involves installing at the switching node 10 a program which is written in a script language and which supports remote access. Script languages provided for use on the Internet are, by way of example, PHP, accordingly the Hypertext Pre-Processor, Java Script, VB Script, accordingly Visual Basic Script, and DTML, accordingly Document Template Mark-up Language. For variant B, it is assumed that a script is incorporated as part of the UPnP application 30 at the switching node 10. Remote access is then used to address the script, and at the same time the remote access is used to transfer a number of parameters to the script. The script evaluates the parameters and then performs the associated function automatically. This then also includes address conversion in order to address an individual network station specifically. An example of such remote access is likewise shown in FIG. 10. The globally valid IP address of the switching node 10 is specified as domain name in the first part of the HTTP Get call. This is followed by the indication of the script file. In the example, this is the file ua1.html. The transferred parameters are announced by a question mark in the HTTP Get call. First of all, the parameter Device with the value Station3-192168001012 is transferred. Following the and symbol, a second parameter Action is transferred. This has the value CDS, i.e. the HTTP Get call is intended to be used to load the content directory from the station 3. As a third parameter, the path is also transferred. In the example, this is the root directory. The script then needs to be programmed such that it can use the first transferred parameter Device and the internally created tables to perform a required address conversion and can generate the associated network-internal UPnP request to the station 3. The response to the request is converted into an HTML page again, as described above.

FIG. 11 shows an example of remote access to the presentation page on a network station in the local area network with conversion into HTTP access using a local IP address and conversion of the local links or the local links in forms into global links or global links in forms.

FIG. 12 shows the presentation page directory structure on the web server of the network station 3.

FIG. 13 shows an extract from the presentation page index.html on the network station 3 with a link to the device settings and an extract from a form for password input.

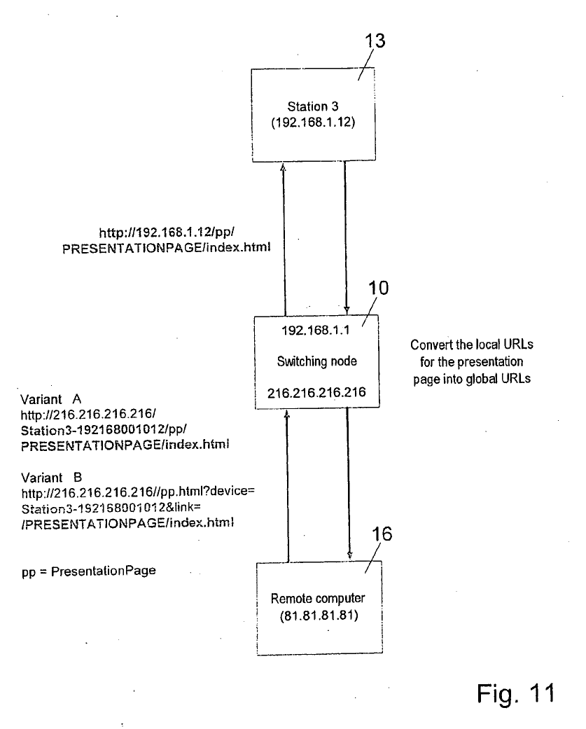

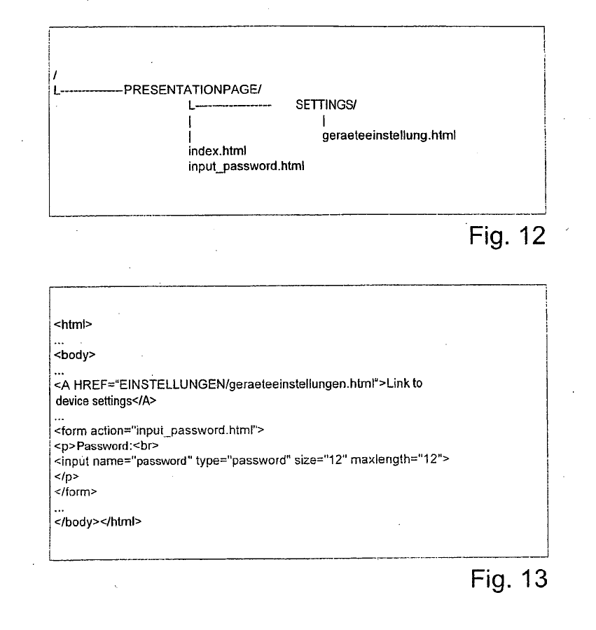

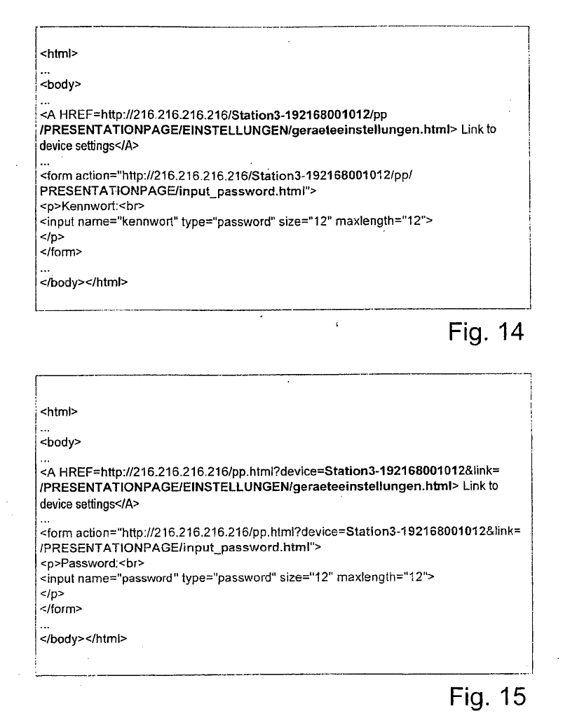

FIG. 14 shows the presentation page index/html from FIG. 13 following conversion of a local link or a local link in a form into a global link or a global link in a form via the switching node 10 using virtual path statements for encoding information for later conversion of the links into the local area network. In the example in FIG. 14, the virtual path statement corresponds to the component which is behind the global address 216.216.216.216. Only such virtual path statements as have the format which said-component itself has allocated in the form station-descriptor-local IP address^{T}/page-type descriptor can be understood, converted or handled by the switching node.

FIG. 15 shows the presentation page index.html from FIG. 13 following conversion by the switching node 10. The switching node 10 has converted the local links on the page into the following form: global IP address of the switching node, path and name of the script program plus script parameters. In this form, the link can be handled or converted by the switching node 10 later.

1. Method for remotely accessing a local area network, particularly a home network, in which the network stations (11 to 14) can be addressed using locally valid addresses, a switching node (10) being provided which has an associated globally valid address for remote access, characterized in that in the event of remote access to a network station (11, 14) with an associated locally valid address the globally valid address is used with an additional information item and the additional information item is used to effect address conversion, where the globally valid address is converted into the locally valid address for the network station (13) which is to addressed.

2. Method according to claim 1, where the response to the remote access involves the inverse address conversion being effected and therefore the sender address entered being the globally valid address plus the additional information item.

3. Method according to claim 1 or 2, where the additional information item corresponds to the local IP address of the addressed network station (11 to 24).

4. Method according to claim 3, where the local IP address is used in converted form, particularly without dot data, the dots being replaced by leading zeros.

5. Method according to one of the preceding claims, where a functionality associated with the device which is to be addressed by remote access is provided by means of an Internet reference, accordingly an Internet link, to a page on the device which has been generated using description language, where the Internet reference indicates the global address of the switching node (10) plus the additional information item.

6. Method according to claim 5, where an application program (30) at the switching node (10) converts a local reference to a page on the device which has been generated using description language into a global Internet reference indicating the global address of the switching node (10) plus the additional information item.

7. Method according to one of the preceding claims, where a functionality associated with the device which is to be addressed by remote access is provided by means of an Internet reference, accordingly an Internet link, to a document (37) programmed using script language, where the Internet reference indicates the global address of the switching node (10) and at least the local IP address of the device is indicated as a parameter to the document (37) programmed using script language.

8. Method according to one of claims 1 to 5, where an application program (30) at the switching node (10) is used to convert the remote access into one or more UPnP commands, and the UPnP response(s) is/are converted into the form of one or more pages on the device which have been generated using description language and which are made available to the remote computer (16).

9. Switching node for carrying out the method according to one of the preceding claims, where the switching node (10) has an associated globally valid address, characterized in that address conversion means (36) are provided which, in the event of remote access to a network station (11 to 14) with a locally valid address, perform conversion of the globally valid address to the locally valid address of the network station (11 to 14) using a communicated additional information item.

10. Switching node according to claim 9, where the switching node (10) has not only the globally valid address associated with it but also a locally valid address for internal communication in a network.

11. Switching node according to claim 9 or 10, having a device ascertainment module (34) which creates a list (38) of the network stations which are present in the network.

12. Switching node according to claim 11, where the device ascertainment module (34) makes available either separate lists for the network stations active in the network and the inactive network stations, or a joint list in which the active or inactive network stations are flagged separately.

13. Switching node according to claim 11 or 12, where the device list (38) records both the locally valid addresses of the network stations and the associated bus addresses.

14. Switching node according to one of claims 9 to 13, having means for generating a wakeup message for an inactive network station which respond when this inactive network station is accessed remotely.

15. Switching node according to claim 14, where the wakeup message corresponds to a Wake-On-LAN data packet.

16. Switching node according to one of claims 9 to 15, where the locally valid address is an IP address which is allocated particularly on the basis of the DHCP protocol, accordingly the Dynamic Host Configuration protocol, or on the basis of the Auto-IP protocol.

17. Switching node according to one of claims 9 to 16, where the globally valid address is a unique IP address.

18. Switching node according to one of claims 13 to 17, where the bus address corresponds to an Ethernet MAC address.

19. Switching node according to one of claims 9 to 18, having means for providing an Internet reference, accordingly an Internet link, to a page on a network station (11 to 14) which has been generated using description language, where the Internet reference indicates the global address of the switching node (10) plus the additional information item.

20. Switching node according to claim 19, where the means for providing the Internet reference are in the form of an application program (30) which converts the local reference to the page on the network station which has been generated using description language into the global Internet reference.

21. Switching node according to one of claims 9 to 20, having an application program (30) at the switching node (10) which is used to convert the remote access into one or more UPnP commands, and the UPnP response(s) is/are converted into the form of one or more pages on the device which have been generated using description language and which are made available to the remote computer (16).

22. Switching node according to one of claims 9 to 21, having means for providing an Internet reference, accordingly an Internet link, to a document (37) programmed using script language, where the Internet reference indicates the global address of the switching node (10) and the document programmed using script language is designed to accept at least the local address of the device which is to be addressed as a parameter.

23. Switching node according to one of claims 9 to 22, where the additional information item corresponds to the local IP address of the addressed network station (11 to 14).

24. Switching node according to claim 23, where the local IP address is used in converted form, particularly without dot data, the dots being replaced by leading zeros.

25. Switching node according to one of claims 9 to 24, where the switching node (10) is in the form of a UPnP control point device, that is to say a UPnP Control Point.
